(19) United States
(12) Patent Application Publication
(10) Pub. No.: US 2001/0051706 A1
(43) Pub. Date: Dec. 13, 2001

(54) TEREPHTHALATE-BASED SULFOPOLYESTERS

(76) Inventors: SCOTT E. GEORGE, Kingsport, TN (US); BERNARD J. MENTRO, Kingsport, TN (US); MICHAEL J. ABROSINI, Kingsport, TN (US)

Correspondence Address: ERIN M HARRIMAN, MORGAN LEWIS & BOCKIUS LLP, 1800 M STREET N W, WASHINGTON, DC, 200365869

(21) Appl. No.: 09/453,717

(22) Filed: Dec. 3, 1999

Related U.S. Application Data
(60) Provisional application No. 60/110,808, filed on Dec. 3, 1998.

(51) Int. Cl. C08G 63/68; C08G 75/00; C08G 63/16

(52) U.S. Cl. 528/293; 528/294; 528/295; 528/308.6

(57) ABSTRACT

This invention relates to water-dispersible sulfopolyesters comprising residues of (i) terephthalic acid; (ii) an amount sufficient to provide water-dispersibility to the sulfopolyester of at least one difunctional sulfomonomer containing at least one sulfonate group bonded to an aromatic ring; (iii) less than 5 mole % of at least one dicarboxylic acid that is not terephthalic acid or a sulfomonomer; (iv) 25 to 90 mole % of at least one polyethylene glycol having the structure:

H—(OCH₂CH₂)ₙ—OH

wherein 2≦n<20 with the proviso that the mole % of the polyethylene glycol is inversely proportional to the quantity n within the range; and (v) from greater than 10 to less than 75 mole % of hydroxyl equivalents of a glycol or mixture of glycols that is(are) not a polyethylene glycol. The water-dispersible sulfopolyesters according to the invention exhibit improved abrasion and blocking resistance when used as sizing compositions. Accordingly, in another embodiment the invention relates to a fibrous article sized with a sizing composition comprising a water-dispersible sulfopolyester as described above and method of making same.

This application claims priority to copending U.S. Provisional Application Ser. No. 60/110,808 filed Dec. 3, 1998, the disclosure of which is hereby incorporated by reference.

### FIELD OF THE INVENTION

This invention relates to water-dispersible sulfopolyesters based on terephthalate units. The sulfopolyesters of the invention have facile dispersibility, excellent dispersion shelf stability, and are useful as textile fiber sizes that possess improved abrasion and blocking resistances.

### BACKGROUND OF THE INVENTION

Water-dispersible sulfopolyesters incorporating terephthalic acid and polyethylene glycol units are well known in the art. Such sulfopolyesters are taught, for example, by U.S. Pat. Nos. 3,546,008, 3,734,874 and 3,779,993. These patents disclose that, to obtain sulfopolyesters with sufficient dispersibility, at least 5 mole % of an additional acid should be used when terephthalic acid is used as the dicarboxylic acid component. U.S. Pat. No. 5,290,631 discloses water-dispersible sulfopolyesters based on recurring structural units of terephthalate, isophthalate, sulfomonomers, ethylene glycol and polyoxyethylene glycol. There is no disclosure of sulfopolyesters based on an acid component comprising less than 5 mole % of an acid other than terephthalic acid or sulfomoner. Indeed, the sulfopolyesters disclosed by this patent contain a combination of 10 to 75 mole % of terephthalate units and 15 to 70 mole % of isophthalate units.

Sulfopolyester compositions that are only dispersible in water/alcohol mixtures are disclosed in U.S. Pat. No. 4,525,524. The sulfopolyesters comprise repeat units derived from a diacid component comprising from 20 to 90 mole % of dimethyl terephthalate or terephthalic acid. The glycol component may contain up to 80 mole %, based on total glycol, of glycols containing 3 to 12 carbon atoms and glycol ethers containing 4 to 12 carbon atoms. None of these compositions are dispersible in water alone.

It is known in the art that the dispersibility of sulfopolyesters can be increased when the glycol component comprises high molecular weight polyethylene glycols. For example, water-dissipatable sulfopolyesters based on high molecular weight polyethylene glycol are disclosed in U.S. Pat. No. 4,233,196. The molecular weight of the polyethylene glycol component ranges from 106 to 22,018 g/mole and the total glycol component comprises less than 15 mole % of polyethylene glycol. Like the patents discussed above, this patent discloses that if terephthalic acid is used as the dicarboxylic acid component of the polyester, desired results are only achieved when at least 5 mole % of an additional acid is used. Further, increasing the molecular weight of the polyethylene glycol results in a polyester with a lower glass transition temperature which in turn leads to blocking of sized particles.

Accordingly, there remains a need for water-dispersible sulfopolyesters based on terephthalate units having facile water dispersibility and improved abrasion and blocking resistance. The present invention answers this need.

### SUMMARY OF THE INVENTION

It has been discovered that water-dispersible sulfopolyesters based substantially on terephthalate units having improved water-dispersibility, abrasion and blocking resistance can be obtained when the acid component contains terephthalate, sulfomonomer, when the sulfomonomer is present in acid form, and less than 5 mole % of an additional acid and wherein the glycol component contains at least 25 mole % and less than 90 mole % at least one polyethylene glycol of the following formula:

H—(OCH₂CH₂)ₙ—OH

where 2≦n<20.

Accordingly, the invention relates to a water-dispersible sulfopolyester comprising:

(i) a terephthalic acid or derivative thereof;

(ii) less than about 5 mole %, based on the total moles of acid, of at least one dicarboxylic acid that is not terephthalic acid or a derivative thereof, or a sulfomonomer;

(iii) about 25 to about 90 mole %, based on total mole % of hydroxyl equivalents, of at least one polyethylene glycol having the structure:

H—(OCH₂CH₂)ₙ—OH

wherein 2≦n<20 and the mole % of the polyethylene glycol present is inversely proportional to the value of n;

(iv) from greater than about 10 to less than about 75 mole %, based on total mole % of hydroxyl equivalents, of a glycol or mixture of glycols that is not a polyethylene glycol; and

(v) an amount sufficient to provide water-dispersibility to the sulfopolyester of at least one difunctional sulfomonomer.

The sulfopolyester contains substantially equal molar proportions of acid equivalents (about 100 mole %) and hydroxyl equivalents (about 100 mole %), such that the total of the acid and the hydroxyl equivalents is equal to about 200 mole %. The inherent viscosity of the sulfopolyesters according to the invention is at least 0.1 dL/g measured in a 60/40 parts by weight solution of phenol/tetrachloroethane at 25° C. at a concentration of about 0.25 g of polymer in 100 ml of the solvent.

The difunctional sulfomonomer which provides water-dispersibility to the water- dispersible sulfopolyesters of the invention is selected from a dicarboxylic acid or derivative thereof containing at least one sulfonate group bonded to an aromatic ring, a diol containing at least one sulfonate group bonded to an aromatic ring, and a hydroxy acid or derivative thereof containing at least one sulfonate group bonded to an aromatic ring.

The water-dispersible sulfopolyesters according to the invention exhibit improved abrasion and blocking resistance when used as sizing compositions. Accordingly, in another embodiment the invention relates to a fibrous article sized with a sizing composition comprising a water-dispersible sulfopolyester as described above.

### DETAILED DESCRIPTION OF THE INVENTION

The invention relates to water-dispersible sulfopolyesters substantially based on terephthalate units having improved water-dispersibility, abrasion and blocking resistance. Such sulfopolyesters have an acid component that contains terephthalate, sulfomonomer, if the sulfomonomer is present in acid form, and less than 5 mole % of an additional acid and a glycol component comprising at least 25 mole % and less than 90 mole % of at least one polyethylene glycol of the following formula:

H—(OCH₂CH₂)ₙ—OH

where 2≦n<20.

The term “water-dispersible” is often used interchangeably with other descriptors, such as “water dissipatable,” “water-soluble,” or “water-dispellable.” In the context of this invention, all of these terms are to refer to the activity of water on the sulfopolyesters described herein. It is intended for this terminology to include conditions where the sulfopolyester is dissolved to form a true solution or is dispersed within the aqueous medium to obtain a stable product. Often, due to the statistical nature of polyester compositions, it is possible to have soluble and dispersible fractions when a single sulfopolyester is acted upon by an aqueous medium.

As discussed above, the invention relates to a water-dispersible sulfopolyester comprising:

(i) a terephthalic acid or derivative thereof;

(ii) less than about 5 mole %, based on the total moles of acid, of at least one dicarboxylic acid that is not terephthalic acid or a derivative thereof, or a sulfomonomer;

(iii) about 25 to about 90 mole %, based on total mole % of hydroxyl equivalents, of at least one polyethylene glycol having the structure:

H—(OCH₂CH₂)ₙ—OH

wherein 2≦n<20 and the mole % of the polyethylene glycol present is inversely proportional to the value of n;

(iv) from greater than about 10 to less than about 75 mole %, based on total mole % of hydroxyl equivalents, of a glycol or mixture of glycols that is not a polyethylene glycol; and

(iv) an amount sufficient to provide water-dispersibility to the sulfopolyester of at least one difunctional sulfomonomer.

The sulfopolyester contains substantially equal molar proportions of acid equivalents (about 100 mole %) and hydroxyl equivalents (about 100 mole %), such that the total of the acid and the hydroxyl equivalents is equal to about 200 mole %. The water-dispersible sulfopolyesters according to the invention have an inherent viscosity of at least 0.1 dL/g measured in a 60/40 parts by weight solution of phenol/tetrachloroethane at 25° C. at a concentration of about 0.25 g of polymer in 100 ml of the solvent. Preferably, the inherent viscosity is at least 0.25 dL/g, more preferably 0.3 dL/g. For improved adhesive properties, the glass transition temperature of the water-dispersible sulfopolyesters according to the invention is preferably at least 25° C., more preferable from 25 to 75° C., and most preferably from 30 to 65° C.

As discussed above, the water-dispersible sulfopolyester according to the invention contain terephthalic acid as the acid component wherein at least 95 mole % of the total moles of acid comprises a combination of terephthalic acid and sulfomonomer, if the sulfomonomer is present in the acid form. In the context of the invention, the term “terephthalic acid” encompasses the use of terephthalic acid as well as the corresponding acid anhydrides, esters, and acid chloride derivatives. Preferred terephthalic diesters useful in the sulfopolyesters according to the invention include dimethyl terephthalate, however, it is also acceptable to include higher order alkyl esters, such as ethyl, propyl, isopropyl and butyl. In addition, aromatic esters, particularly phenyl, may also be used. Preferably, the terephthalic acid component is selected from terephthalic acid and dimethyl terephthalate.

As discussed above, the sulfopolyesters of the invention contain less than 5 mole % of an additional dicarboxylic acid that is not a terephthalic acid or derivative thereof, or a sulfomonomer. Preferably, the sulfopolyesters according to the invention are free from any additional acid, i.e., component (ii). Examples of dicarboxylic acids that may be used as component (ii) include aliphatic dicarboxylic acids, alicyclic dicarboxylic acids, aromatic dicarboxylic acids, or mixtures of two or more of these acids. Preferred dicarboxylic acids include, but are not limited to succinic; glutaric; adipic; azelaic; sebacic; fumaric; maleic; itaconic; 1,3-cyclohexane dicarboxylic; 1,4-cyclohexanedicarboxylic; diglycolic; 2,5-norbornanedicarboxylic; isophthalic; 1,4-naphthalenedicarboxylic; 2,5-naphthalenedicarboxylic; diphenic; 4,4′-oxydibenzoic; and 4,4′-sulfonyldibenzoic. The term “dicarboxylic acid” includes the use of the corresponding acid anhydrides, esters, and acid chlorides of these acids. Compared with acid anhydrides and acid chlorides the diesters are preferred and the dimethyl esters are most preferred. It is also acceptable to include the higher order alkyl esters, such as ethyl, propyl, isopropyl, butyl, and so forth. In addition, aromatic esters, particularly phenyl, may also be considered.

The polyethylene glycol component, (iii), provides hydrophilic, but non-ionic, moieties within the sulfopolyester backbone. In addition to the benefit of tailoring the hydrophilicity of the sulfopolyester, a number of other advantages may be obtained by virture of the polyethylene glycol. For example, lower melt viscosity, improved adhesion, and increased abrasion resistance, may be realized from specific glycol compositions. However, simply maximizing the amount of polyethylene glycol (PEG) does not lead to the most facile dispersibilty or dispersion clarity/stability. The best results are obtained when the hydrophilic glycol (i.e., the PEG component (iii) is combined with a hydrophobic glycol (i.e., a glycol component that is more hydrophobic than the PEG component) to provide the best combination of dispersibility at a Tg greater than 25° C. Suitable hydrophobic glycols (i.e., glycol component (iv)) useful in the sulfopolyesters of the invention are discussed below.

As the molecular weight of the PEG increases the maximum level of incorporation will decrease. In other words, the molecular weight and the mole % of the PEG component (iii) are inversely proportional to each other. Specifically, as the molecular weight is increased the mole % of PEG will be decreased. Generally, the mole % of PEG ranges from about 25 to 90 mole % based on the total mole % of hydroxyl equivalents. In a preferred embodiment, a PEG having a molecular weight of 106 (i.e., n=2) may constitute up to 90 mole % of the total glycol, while a PEG having a molecular weight of 850 (i.e., n=19) would typically be incorporated at a level of less than ten (10) mole percent of the total glycol.

The PEG component (iv) has the following general formula:

HO—(CH₂CH₂—O)ₙ—H

where n is at least 2, but less than 20. Preferably, 2≦n≦10 and more preferably 2≦n≦6. Most preferred are the lower molecular weight polyethylene glycols: diethylene glycol, triethylene glycol, and tetraethylene glycol.

It is important to recognize that certain glycols of (iv) may be formed in-situ, due to side reactions that may be controlled by varying the process conditions. A specific example of this is the formation of varying proportions of diethylene, triethylene, and tetraethylene glycols from ethylene glycol due to an acid-catalyzed dehydration, which occurs readily when a buffer is not added to raise (i.e., less acidic) the pH of the reaction mixture. Additional compositional latitude is possible if the buffer is omitted from a feed containing various proportions of ethylene and diethylene glycols or ethylene, diethylene, and triethylene glycols and combinations so forth.

As discussed above, improved dispersibility is obtained when the glycol component of the sulfopolyesters of the invention comprises a hydrophobic glycol in combination with the PEG component (iii) discussed above. Suitable hydrophobic glycols, i.e., component (iv) of the sulfopolyesters of the invention, include aliphatic, alicyclic and aralkyl glycols and comprise greater than about 10 mole % to less than about 75 mole % of the total mole % of hydroxyl equivalents. More preferably, the glycol component (iv) comprises from about 20 to about 50 mole % of the total mole % of hydroxyl equivalents. Examples of these glycols include ethylene glycol; propylene glycol; 1,3-propanediol; 2,4-dimethyl-2-ethyl-hexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-trimethyl- 1,6-hexanediol; thiodiethanol; 1,2-cyclohexanedimethanol; 1,3-cyclohexane dimethanol; 1,4-cyclohexanedimethanol; 2,2,4,4-tetramethyl-1,3-cyclobutanediol; p-xylylenediol. Ethylene glycol is preferred.

The difunctional sulfomonomer which provides water-dispersibility to the water-dispersible sulfopolyesters of the invention is selected from a dicarboxylic acid or derivative thereof containing at least one sulfonate group bonded to an aromatic ring, a diol containing at least one sulfonate group bonded to an aromatic ring, and a hydroxy acid or derivative thereof containing at least one sulfonate group bonded to an aromatic ring. The difunctional sulfomonomer, may advantageously be a dicarboxylic acid or ester thereof containing a sulfonate group (13 SO₃M) or a diol containing a sulfonate group derived from the reaction product of a dicarboxylic acid or ester thereof with a glycol. The cation of the sulfonate salt may be a metal ion, such as Li⁺, Na⁺, K⁺, Mg⁺⁺, Ca⁺⁺, Cu⁺⁺, Ni⁺⁺, Fe⁺⁺⁺and the like. It is within the boundaries of this disclosure that the sulfonate salt is non-metallic and may be a nitrogenous base as described in U.S. Pat. 4,304,901, the disclosure of which is herein incorporated by reference. Suitable nitrogen based cations are derived from nitrogen containing bases, which may be aliphatic, cycloaliphatic, or aromatic compounds that have ionization constants in water at 25° C. of 10⁻³ to 10⁻¹⁰, preferably 10⁻⁵ to 10^{-8.} Examples of suitable nitrogen containing bases are ammonia, pyridine, morpholine, and piperidine.

It is known that the choice of cation will influence, often markedly, the water-dispersibility of the resulting polymer. Depending on the end-use application of the polymer, either a more or less easily dispersible product may be desirable. It is possible to prepare the sulfopolyester using, for example, a sodium sulfonate salt and then by ion-exchange methods replace the sodium with a different ion, such as zinc, when the polymer is in the dispersed form. This type of ion-exchange procedure is generally superior to preparing the polymer with divalent and trivalent salts inasmuch as the sodium salts are usually more soluble in the polymer reactant melt-phase. Also, the ion-exchange procedure is usually necessary to obtain the nitrogenous counterions, since amine salts tend to be unstable at typical melt processing conditions.

Preferred difunctional sulfomonomers are those where the sulfonate salt group is attached to an aromatic acid nucleus, such as benzene, naphthalene, diphenyl, oxydiphenyl, sulfonyldiphenyl, or methylenediphenyl. More preferably, the sulfomonomer is selected from sulfophthalic acid, sulfoterephthalic acid, sulfoisophthalic acid, 4-sulfonaphthalene-2,7-dicarboxylic acid, and their esters as described in U.S. Pat. 3,779,993, the disclosure of which is incorporated herein by reference. Even more preferably, the difunctional sulfomonomer is 5-sodiosulfoisophthalic acid or esters thereof. It is preferred that the difunctional sulfomonomer be present in an amount of 6 to 40 mole %, more preferably about 8 to 30 mole %, and most preferably about 9 to 25 mole %, based on the total acid equivalents.

A process for preparing the sulfopolyesters of the present invention involves two distinct stages, an ester-interchange or esterification stage and a polycondensation stage. The ester-interchange or esterification, is conducted under an inert atmosphere at a temperature of 150 to 250° C. for 0.5 to 8 hours, preferably from 180 to 230° C. for 1 to 4 hours. The difunctional sulfomonomer is normally added directly to the reaction mixture from which the polymer is made; other processes are known and may also be employed. Illustrative examples from the art are U.S. Pat. Nos. 3,018,272; 3,075,952; and 3,033,822, the disclosures of which are herein incorporated by reference. The glycols, depending on their reactivities and the specific experimental conditions employed, are commonly used in molar excesses of 1.05 - 2.5 moles per total moles of acid-functional monomers. Preferably, the esterification reaction is conducted at pressures greater than ambient or atmospheric. In either situation an inert atmosphere, such as nitrogen or argon, will provide superior results. The second stage, referred to as polycondensation, is conducted under reduced pressure at a temperature of 230 to 350° C., preferably 240 to 310° C., and more preferably 250 to 290° C. for 0.1 to 6 hours, preferably 0.25 to 2 hours. Stirring or appropriate conditions are used in both stages to ensure adequate heat transfer and surface renewal of the reaction mixture.

The reactions of both stages are facilitated by appropriate catalysts, especially those well-known in the art and taught, for example, by U.S. Pat. Nos. 4,167,395 and 5,290,631, the disclosures of which are hereby incorporated by reference. Suitable catalysts include, but are not limited to, alkoxy titanium compounds, alkali metal hydroxides and alcoholates, salts of organic carboxylic acids, alkyl tin compounds, metal oxides, and so forth. When terephthalic acid is used as one of the starting materials, the esterification stage may be autocatalytic. A three-stage manufacturing procedure, similar to the disclosure of U.S. Pat. No. 5,290,631, the disclosure of which is herein incorporated by reference, may also be used, particularly when a mixed monomer feed of acids and esters is employed. Multistaging is also a useful method to control the glycol composition, as described supra, where ethylene, diethylene, triethylene, etc. are interconverted via adventitious side reactions.

The sulfopolyesters according to the invention are preferably prepared using a buffer. Buffers and their use are well known in the art and one of ordinary skill in the art is well acquainted with their use to prepare sulfopolyesters. Preferred buffers include sodium acetate, potassium acetate, lithium acetate, sodium phosphate monobasic, potassium phosphate dibasic and sodium carbonate. The buffer is present in an amount of up to 0.2 moles per mole of difunctional sulfomonomer. Preferably, the buffer is present in an amount of about 0.1 moles per mole of difunctional sulfomonomer.

Aqueous dispersions of the water-dispersible sulfopolyesters of the invention may be obtained by adding molten or solid polymer into water-with sufficient agitation and heating.

As discussed above, the water-dispersible sulfopolyesters according to the invention are particularly useful as textile fiber sizes due to their improved abrasion and blocking resistance. Further, the sulfopolyesters according to the invention have facile dispersibility and excellent dispersion shelf life stability. Thus, one aspect of this invention is directed toward sizing compositions for textile yarns made from linear polyesters and fibrous articles of manufacture sized therewith.

When multifilament polyesters yams are fabricated into textiles it is desirable to treat the warp yam, before weaving, with a sizing composition that adheres and binds at least several filaments together. The treatment process, known as “sizing,” imparts strength and abrasion resistance to the yarn during the weaving process. In most cases it is also preferred that the sizing composition be completely removable from the woven fabric, sometimes referred to as “desizing.” Increased abrasion resistance will result in fewer breaks during the weaving process, which improves the quality of the textile product and process speed and process speed. Although the described application is in reference to polyester yarns, such as poly(ethylene terephthalate) or poly(1,4-cyclohexanedimethylene terephthalate), the compositions described hereinafter may be used as sizes for a variety of natural and synthetic yarns. Examples of non-polyester yarns include rayon, acrylic, polyolefin, cotton, nylon, and cellulose acetate. Blends of polyester and non-polyester yams are also within the scope of fibers that may be effectively sized.

Accordingly, in another embodiment the invention relates to a method for the sizing of a textile yarn by applying thereto the water-dispersible sulfopolyesters of the invention in an aqueous medium. Generally, the textile yarn is immersed in an aqueous bath containing the sulfopolyester at the desired concentration (e.g. 1-30 wt%) and temperature (e.g. 60-100° C.), followed by the draining of the textile yarn by passing them between rollers and, finally, the drying of the sized threads in drying chambers, the tow then being ready for weaving. Conventional methods for sizing a filament yarn include European system, the classic or English system and the single end sizing or Japanese system.

In one embodiment, the sized textile yarn is subjected to a desizing operation to remove the sizing composition prior to bleaching, dyeing and finishing operations. In another embodiment, the sizing composition is permanently applied to the textile yarn, for example, through the use of a crosslinking agent as is known in the art and taught, for example, by U.S. Pat. Nos. 3,767,207 and 3,666,400, the disclosures of which is herein incorporated by reference.

Sizing compositions according to the invention are aqueous dispersions generally comprising from about 1 to about 30 wt. %, preferably 1 to about 30 wt. %, of a sulfopolyester according to the invention depending on the style of the yarn. Various additives may be incorporated into the sizing compositions of the invention as is known in the art and taught, for example, by U.S. Pat. No. 3,546,008, the disclosure of which is herein incorporated by reference. Examples of suitable additives include talc, whiteners, dyes, thickening agents, buffers, biocides, and stabilizers.

The size compositions should possess adequate resistance to blocking, which is most critically manifested when the fiber is wound on a warp beam or bobbin and stored for extended periods of time under ambient conditions. Blocking causes the sized fibers to meld together, which inhibits them from being unwound at the desired time. The tendency for blocking to occur under both normal and extreme ambient conditions of temperature and humidity may be directly related to the Tg of the size composition. Therefore, a dry Tg ranging from 25 to 75° C., preferably 30 to 65° C., and more preferably from 35 to 60° C. generally avoids blocking problems. A very high (>75° C.) Tg often indicatives a brittle sulfopolyester that would possess poor adhesion, manufacturability, and abrasion resistance. Hence, consideration should be given to the selection of the glycol component; for example too high a level of PEG can detrimentally lower the Tg and result in blocking. In general, as the length or molecular weight of a polyethylene glycol monomer is increased, at a constant molar percentage of incorporation, the Tg of the final polymer will be proportionately decreased.

Adhesion, flexibility and, in part, desizability and water resistance are also related to the PEG molecular weight and content of the sulfopolyester. As the PEG consent is increased, hydrophilicity, flexibility, and adhesion are also increased. If the PEG content and/or molecular weight is too high, then the resulting size will have a low Tg and marginal water resistance. The properties of desizability, water resistance, flexibility, and adhesion are also related to the content of sulfomonomer. If the sulfomonomer level is too high, the water resistance, flexibility, and economics of the size will be lessened, while a functionally low level of sulfomonomer tends to detract from the adhesion, dispersibility, and will prevent adequate desizing after the weaving operation.

For optimum size performance, the inherent viscosity of the sulfopolyester is at least 0.25 dL/g, preferably greater than 0.3 dL/g and the glass transition temperature (Tg) is at least 25° C., preferably from 30 to 65° C.

Accordingly, in a preferred embodiment, the size material according to the invention is a water-dispersible sulfopolyester, having a dry Tg ranging from 30 to 65° C. and an inherent viscosity of at least 0.1 dL/g measured in a 60/40 parts by weight solution of phenol/tetrachloroethane at 25° C. at a concentration of about 0.25 g of polymer in 100 ml of the solvent and comprising:

(i) a terephthalic acid or derivative thereof;

(ii) less than about 5 mole %, based on the total moles of acid, of at least one dicarboxylic acid that is not terephthalic acid or a derivative thereof, or a sulfomonomer;

(iii) about 25 to about 90 mole %, based on total mole % of hydroxyl equivalents, of at least one polyethylene glycol having the structure:

H—(OCH₂CH₂)ₙ—OH

wherein 2≦n<20 and the mole % of the polyethylene glycol present is inversely proportional to the value of n;

(iv) from greater than about 10 to less than about 75 mole %, based on total mole % of hydroxyl equivalents, of a glycol or mixture of glycols that is not a polyethylene glycol; and

(v) an amount sufficient to provide water-dispersibility to the sulfopolyester of at least one difunctional sulfomonomer selected from a dicrboxylic acid or derivative thereof containing at least one sulfonate group bonded to an aromatic ring, a diol containing at least one sulfonate group bonded to an aromatic ring, and a hydroxy acid or derivative thereof containing at least one sulfonate group bonded to an aromatic ring; wherein the sulfopolyester contains substantially equal molar proportions of acid equivalents (about 100 mole %) and hydroxyl equivalents (about 100 mole %), such that the total of the acid and the hydroxyl equivalents is equal to about 200 mole %.

### EXAMPLES

The following Examples are intended to illustrate, but not limit, the scope of this invention. The materials and testing procedures used for the results shown herein are as follows:

Abrasion resistance for sized yarn is measured using the Duplan Cohesion Tester, as is well known to those in the art. The Duplan test is performed on samples of sized yarn, under constant tension, that are abraded by friction plates moving back and forth over the yam at a constant rate. The average number of cycles to separate the yarn filaments is reported as the abrasion resistance or Duplan value. Hence, higher Duplan values are a direct indicator of the suitability of the sulfopolyester as a size material.

Glass transition temperature (Tg) was determined using a differential scanning calorimeter (DSC).

Inherent viscosity (IV) was measured in a 60/40 parts by weight solution of phenol/tetrachloroethane at 25° C. at a concentration of about 0.25 g of polymer in 100 ml of the solvent.

Examples 1 and 2 illustrate the in-situ formation of useful glycol combinations. Example 3 shows how a buffer may be used to control the glycol composition relative to the feed. Example 4 is a preferred embodiment of the invention. Examples 5 and 6 are included for comparison to demonstrate the importance of appropriate glycol selection to obtain a sufficiently high Tg (Example 5) or a processable polymer (Example 6). Example 7 is a comparative example while Example 8 is a preferred embodiment of the invention. Example 9 compares the abrasion resistance of the sulfopolyester of Example 1 with a commercially available sulfopolyester size product. Example 10 is an example of a sulfopolyester using 5 mole % of additional acid

### Example 1

### Preparation of Water-Dispersible Sulfopolyester Containing 11 Mole % 5-Sodiosulfoisophthalate with 70 Mole % Mixed PEG

A 500 mL round bottom flask equipped with a ground-glass head, agitator shaft, nitrogen inlet, and a sidearm to allow for removal of volatile materials was charged with 86.3 grams (0.445 mole) dimethyl terephthalate, 16.3 grams (0.055 mole) dimethyl-5-sodiosulfoisophthalate, 36.0 grams (0.58 mole) ethylene glycol, 44.5 grams (0.42 mole) diethylene glycol, and 1.10 mL of a 1.03% (w/v) solution of titanium isopropoxide in n-butanol. The flask was purged with nitrogen and immersed in a Belmont metal bath at 200° C. for 70 minutes and 210° C. for an additional 120 minutes under a slow nitrogen sweep with sufficient agitation. After elevating the temperature to 275° C., the pressure was gradually reduced from 760 mm to 0.5 mm over the course of 35 minutes and held for an additional 85 minutes to perform the polycondensation. The vacuum was then displaced with a nitrogen atmosphere and the clear, amber polymer was allowed to cool before removal from the flask. An inherent viscosity of 0.56 dL/g was determined for the recovered polymer according to ASTM D3835-79. NMR analysis indicated that the actual glycol composition was 30 mole % EG, 56 mole % DEG, and 14 mole % TEG that was formed via side reactions. A glass transition temperature (Tg) of 38° C. was obtained for the polymer from thermal analysis by DSC. The polymer was ground to a particle size of <3 mm.

### Example 2

### Preparation of Water-Dispersible Sulfopolyester Containing 11 Mole % 5-Sodiosulfoisophthalate and 82 Mole % Mixed PEG

The apparatus and general procedure described in Example 1 was used with the exception that polycondensation time was changed. The amounts initially charged to the flask were: 86.3 grams (0.445 mole) dimethyl terephthalate, 16.3 grams (0.055 mole) dimethyl-5-sodiosulfoisophthalate, 26.7 grams (0.43 mole) ethylene glycol, 60.4 grains (0.57 mole) diethylene glycol, and 1.14 mL of a 1.03% (w/v) solution of titanium(IV)isopropoxide in n-butanol. The polycondensation was performed at 275° C. for 120 minutes at a pressure 0.2 mm of Hg. The recovered polymer had an inherent viscosity of 0.55 (ASTM D3835-79) and a dry Tg, as measured by DSC, of 34° C. Analysis by NMR indicated that the actual glycol composition was 18 mole % EG, 68 mole % DEG, and 14 mole % TEG. The clear yellow polymer was ground to a particle size ≦3 mm.

### Example 3

### Preparation of Water-Dispersible Sulfopolyester Containing 15 Mole % 5-Sodiosulfoisophthalate and 72 Mole % DEG

The apparatus and general procedure described in Example 1 was used with the exception that the transesterification and polycondensation times were changed. The initial reactant charge consisted of: 82.5 grams (0.425 mole) dimethyl terephthalate, 22.2 grams (0.075 mole) dimethyl-5-sodiosulfoisophthalate, 11.2 grams (0.18 mole) ethylene glycol, 76.3 grams (0.72 mole) diethylene glycol, 0.62 grams (0.0075 mole) sodium acetate, and 0.44 mL of a 1.46% (w/v) solution of titanium(IV)isopropoxide in n-butanol. The polyesterification was conducted at 200° C. for 60 minutes and 230° C. for 90 minutes, followed by a polycondensation stage at 280° C. and 6 mm Hg for 104 minutes. Inherent viscosity and Tg values of 0.39 and 49° C., respectively, were obtained in the same manner as described previously. NMR analysis indicated the polymer acid composition was consistent with 85 mole % terephthalate, 15 mole % 5-sodiosulfoisophthalate units, while the glycol portion consisted of 28 mole % EG and 72 mole % DEG.

### Example 4

### Preparation of Water-Dispersible Sulfopolyester from Terephthalic Acid

A 316 SS Parr high pressure reactor equipped with a stirrer, heat transfer coil, and distillation column was charged with 739.6 grams (4.46 mole) terephthalic acid, 147.5 grams (0.55 mole) 5-sodiosulfoisophthalic acid, 446.1 grams (4.2 mole) diethylene glycol, and 360.0 grams (5.8 mole) ethylene glycol. Nitrogen was used to institute a pressure of 40 psig and a temperature of 225° C. was maintained for 60 minutes, followed by an 80 minute hold time at 245° C. Water was removed through the column, which was maintained at 150° C. The solid oligomer from the above reaction was removed from the Parr reactor and transferred to a 500 mL round bottom flask equipped with a ground-glass head, agitator shaft, nitrogen inlet, and a sidearm to allow for removal of volatile materials. After purging the flask with nitrogen, enough catalyst solution was added to provide 100 ppm of titanium. The reactor was then immersed in a Belmont metal bath at 225° C. for 10 minutes to melt the oligomer and then the temperature was increased to 275° C. before a vacuum of 0.6 mm was attained and held for 35 minutes to perform the polycondensation. Nitrogen was used to displace the vacuum and the polymer was allowed to cool before removal from the flask. The polymer was ground to a particle size of ≦6 mm before analysis. An inherent viscosity of 0.73 dL/g was determined and GC analysis showed the glycol composition to be 25 mole % EG, 44 mole % DEG, and 31 mole % TEG. A glass transition temperature of 26° C. was obtained for the polymer from thermal analysis by DSC.

### Comparative Example 5

### Preparation of Water-Dispersible Sulfopolyester Containing 7 Mole % 5-Sodiosulfoisophthalate and TEG

The apparatus and procedure used were the same as Example 1 with the exception that the transesterification was conducted at 200° C. for 60 minutes and 230° C. for 90 minutes, while the polycondensation was performed at 280° C. and 0.5 mm for 95 minutes. The reactants and their respective amounts were: 89.2 grams (0.46 mole) dimethyl terephthalate, 11.8 grams (0.04 mole) dimethyl-5-sodiosulfoisophthalate, 150.0 grams (1.0 mole) triethylene glycol, 0.33 grams (0.004 mole) sodium acetate, and 0.64 mL of a 1.46% (w/v) solution of titanium(IV)isopropoxide in n-butanol. The recovered polymer was analyzed in the same manner as described previously and an inherent viscosity of 0.52 dL/g and a Tg of 4° C. were obtained. NMR analysis determined that the polymer structure (total mole % =200 containing equal amounts of acid and glycol units) was comprised of 93 mole % terephthalate, 7 mole % 5-sodiosulfoisophthalate and 100 mole % TEG. The low Tg of this polymer would lead to blocking. When dispersed at 30% solids, a cloudy, unstable (i.e., phase separated) product was obtained.

### Comparative Example 6

### Preparation of Water-Dispersible Sulfopolyester Containing 30 Mole % 5-Sodiosulfoisophthlate and EG

The apparatus and procedure used were the same as Example 1 with the exception that the transesterification was conducted at 160° C. for 120 minutes; the temperature was then increased to 230° C. before the pressure was gradually reduced over the course of 25 minutes to 0.35 mm of Hg. After a polycondensation time of approximately 25 minutes, the reaction was terminated as the polymer had wrapped itself around the agitator due to an extremely high melt viscosity. The initial reactant charge consisted of: 67.9 grams (0.35 mole) dimethyl terephthalate, 44.4 grams (0.15 mole) dimethyl-5-sodiosulfoisophthalate, 62.0 grams (1.0 mole) ethylene glycol, 0.5 grams (0.006 mole) sodium acetate, 0.25 g of antimony(III)oxide, and 0.25 g of zinc(II)acetate. Inherent viscosity and Tg values of 0.11 and 97° C., respectively were obtained as before. NMR analysis indicated the polymer composition was consistent with 71.5 mole % terephthalate, 28.5 mole % 5 sodiosulfoisophthalate, 91 mole % EG, and 9 mole % DEG structural units. The extremely high melt viscosity of the polymer would prevent manufacturing in typical equipment and thus would not be suitable for this invention.

### Examples 7 and 8

### Comparison of Fiber Sizing Properties

Table 1 shows the comparative fiber sizing properties of polymers synthesized in accordance with the previous Examples. Both of the polymers were dispersed in deionized water at a solids level of 30 weight % and diluted appropriately for slashing. The typical procedure for dispersion was to heat the water to 80 - 90° C. and sift in the solid pellets with good agitation.

Fiber testing was accomplished by passing (i.e., slashing) a 150 denier warp drawn polyester yarn through an aqueous dispersion of the size composition and drying. The results in Table 1 demonstrate that incorporation of greater than 5 mole % of a co-acid (i.e., isophthalic acid) results in a size that has essentially equivalent blocking resistance than a similar composition containing only terephthalic acid. The preferred embodiment, Example 8, has a lower Tg than Example 7, which supports the non-obviousness and efficacy of all-terephthalate sulfopolyesters as size materials. As is known to those skilled in the art, lowering the Tg of a sulfopolyester normally increases the blocking tendency. Example 7 is outside the scope and teachings of this invention and is included for the sole purpose of distinguishing these non-obvious teachings from the prior art, while Example 8 is a preferred embodiment of the present invention. Pickup level or the amount of dry size applied to the fiber was essentially constant for both of the Examples.

TABLE 1
Comparative Data for Blocking Properties

| EXAMPLE | Composition | | % | |
|---|---|---|---|---|
| Number | (Mole %)* | Tg (° C.) | Pickup | Blocking |
| 7 | T = 74, I = 16 | 42 | 6.0 | 2.6 |
| | SIP = 11, EG = 47, | | | |
| | DEG = 33, TEG = 20 | | | |
| 8 | T = 87, SIP = 13 | 37 | 6.2 | 2.9 |
| | EG = 40, DEG = 40, | | | |
| | TEG = 20 | | | |

*Total acid and glycol = 200 mole %
T = dimethyl terephthalate
SIP = dimethyl-5-sodiosulfoisophthalate
EG = ethylene glycol
DEG = diethylene glycol
TEG = triethylene glycol

The blocking test is performed by winding 500 meters of sized yarn onto a spool and conditioning at 40° C. and 90% Relative Humidity for 7 days. The average force required to unwind the yam was determined by sampling the output of a tensiometer 25 times/second for 2 minutes to ensure a high degree of precision. The 3000 readings were averaged and the final blocking value is reported as a number in volts. Values will range from 0 - 5 with the higher the value, the greater the amount of blocking.

### Example 9

### Comparative Abrasion Resistance

A sulfopolyester, prepared in the same manner as Example 1, was compared to a commercially available sulfopolyester size product (Eastman WD Size) for abrasion resistance. The results are shown in Table 2 where the abrasion resistance is reported as the number of Duplan cycles obtained for a sized natural yarn. Excellent abrasion resistance is known to directly relate to good weaving efficiency.

TABLE 2
Comparative Data for Abrasion Resistance

| | Composition* | | |
|---|---|---|---|
| EXAMPLE | (mole %) | % Add-on | Duplan cycles |
| 9 | T = 89, SIP = 11, | 9.4 | 73 |
| | EG = 31, DEG = 55, | | |
| | TEG = 14 | | |
| — | Eastman WD Size | 9.1 | 18 |

*Total acid and glycol = 200 mole %
T = dimethyl terephthalate
SIP = dimethyl-5-sodiosulfoisophthalate
EG = ethylene glycol
DEG = diethylene glycol
TEG = triethylene glycol

The test procedure consisted of stringing the yam 20 times across the test fixture and passing a 417 gram sled back and forth until failure was noted. Testing was conducted in 3-cycle increments and failure was correlated to the separation of any filaments in at least half of the yarns. The higher the number of cycles, the greater the abrasion resistance.

### Example 10

### Preparation of a Water-Dispersible Sulfopolyester using up to 5 Mole % of an Additional Acid

A 1000 mL round bottom flask equipped with a ground glass head, agitator shaft, nitrogen inlet, and a sidearm for removal of volatile by-products was charged with 163.0 g (0.84 moles) dimethyl terephthalate, 8.3 grams (0.05 moles) isophthalic acid, 32.6 g (0.11 moles) dimethyl-5-sodiosulfoisophthalate, 91.2 grams (0.86 moles) diethylene glycol, 71.9 grams (1.2 moles) ethylene glycol, and 2.34 mL of a 0.98% (w/v) solution of titanium(IV)isopropoxide in n-butanol. The flask was purged with nitrogen and immersed in a Belmont metal bath at 200° C. for 70 minutes and 210° C. for an additional 120 minutes under a slow nitrogen sweep and a stirring rate of 200 rpm. After increasing the temperature to 275° C., the pressure was gradually reduced from 760 mm to <1 mm over the course of 25 minutes. The pressure was held at <1 mm for 13 minutes, increased to 10 mm and held for an additional 34 minutes to complete the polycondensation. Nitrogen was used to displace the vacuum and the clear, light yellow polymer melt was allowed to cool before recovery. The resulting glassy polymer had an inherent viscosity of 0.44 dL/g (ASTM D3835-79) and a dry (second run) Tg of 39° C. Analysis by hydrolysis GC indicated the actual glycol composition to be 32 mole % EG, 56 mole % DEG, and 12 mole % TEG.

The claimed invention is:

1. A water-dispersible sulfopolyester having an inherent viscosity of at least 0.1 dL/g measured in a 60/40 parts by weight solution of phenol/tetrachloroethane at 25° C. at a concentration of about 0.25 g of polymer in 100 ml of the solvent and comprising:
(i) a terephthalic acid or derivative thereof;
(ii) less than about 5 mole %, based on the total moles of acid, of at least one dicarboxylic acid that is not terephthalic acid or a derivative thereof, or a sulfomonomer;
(iii) about 25 to about 90 mole %, based on total mole % of hydroxyl equivalents, of at least one polyethylene glycol having the structure:
H—(OCH₂CH₂)ₙ—OH
wherein 2≦n<20 and the mole % of the polyethylene glycol present is inversely proportional to the value of n;
(iv) from greater than about 10 to less than about 75 mole %, based on total mole % of hydroxyl equivalents, of a glycol or mixture of glycols that is not a polyethylene glycol; and
(v) an amount sufficient to provide water-dispersibility to the sulfopolyester of at least one difunctional sulfomonomer selected from a dicrboxylic acid or derivative thereof containing at least one sulfonate group bonded to an aromatic ring, a diol containing at least one sulfonate group bonded to an aromatic ring, and a hydroxy acid or derivative thereof containing at least one sulfonate group bonded to an aromatic ring;
wherein the sulfopolyester contains substantially equal molar proportions of acid equivalents (about 100 mole %) and hydroxyl equivalents (about 100 mole %), such that the total of the acid and the hydroxyl equivalents is equal to about 200 mole %.

2. The sulfopolyester of claim 1, wherein
the terephthalic acid or derivative thereof component (i) is selected from the group consisting of terephthalic acid, dimethyl terephthalate, and mixtures thereof;
the dicarboxylic acid component (ii) is selected from the group consisting of: succinic acid; glutaric acid; adipic acid; azelaic acid; sebacic acid; fumaric acid; maleic acid; itaconic acid; 1,3-cyclohexane dicarboxylic acid; 1,4-cyclo-hexanedicarboxylic acid; diglycolic acid; 2,5-norbornanedicarboxylic acid; isophthalic acid; 1,4-naphthalenedicarboxylic acid; 2,5-naphthalenedicarboxylic acid; diphenic acid; 4,4′-oxydibenzoic acid; 4,4′-sulfonyldibenzoic acid; and mixtures thereof;
in the polyethylene glycol component (iii), the value of n is 2≦n ≦10;
the glycol component (iv) is selected from the group consisting of an aliphatic glycol, an alicyclic glycol, an aralkyl glycol, and mixtures thereof; and the difunctional sulfomonomer component (v) is a dicarboxylic acid or derivative thereof containing at least one sulfonate group bonded to an aromatic ring.

3. The sulfopolyester of claim 1, wherein
the terephthalic acid or derivative thereof is selected from the group consisting of terephthalic acid and dimethyl terephthalate and is present at greater than 60 mole % based on the total acid equivalents;
the polyethylene glycol, component (iii) is present at from 80 to 50 mole % and the value of n is n is 2≦n≦6;
the glycol, component (iv), is selected from the group consisting of ethylene glycol; propylene glycol; neopentyl glycol; 1,2-propanediol; 1,3-propanediol; 2,4-dimethyl-2-ethyl-hexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-trimethyl-1,6-hexanediol; thiodiethanol; 1,2-cyclohexanedimethanol; 1,3-cyclohexane-dimethanol; 1,4-cyclohexanedimethanol; 2,2,4,4-tetramethyl-1,3-cyclobutanediol; and p-xylylenediol and is present at from 20 to 50 mole % based on the total hydroxyl equivalent; and
the difunctional sulfomonomer is selected from the group consisting of sulfophthalic acid and esters thereof, sulfoterephthalic acid and esters thereof, sulfoiosphthalic acid and esters thereof, 4-sulfonaphthalene-2,7-dicarboxylic acid and esters thereof, 5-sodiosulfoisophthalic acid and esters thereof, and mixtures thereof and is present at from about 6 to about 40 mole %, based on the total acid equivalents.

4. The sulfopolyester of claim 1, wherein said sulfopolyester is free from any dicarboxylic acid that is not terephthalic acid or a derivative thereof, or a sulfomonomer.

5. The sulfopolyester of claim 3, wherein the difunctional sulfomonomer is 5-sodiosulfoisophthalic acid or the esters thereof and is present in an amount of from about 8 to about 30 mole %, based on the total acid equivalents.

6. The sulfopolyester of claim 5, wherein the difunctional sulfomonomer is present in an amount from about 9 to about 25 mole %, based on the total acid equivalents.

7. The sulfopolyester of claim 1, wherein the glycol, component (v), is selected from the group consisting of diethylene glycol, triethylene glycol and tetraethylene glycol.

8. The sulfopolyester of claim 1, wherein the inherent viscosity is at least 0.25 dL/g and the Tg is at least 25° C.

9. The sulfopolyester of claim 1, wherein the inherent viscosity is at least 0.3 dL/g and the Tg ranges from 25° C. to 75° C.

10. The sulfopolyester of claim 1, wherein the Tg ranges from 30° C. to 65° C.

11. A sizing composition comprising from about 1 to about 25 wt. % of a sulfopolyester according to claim 1.

12. A fibrous article sized with a sizing composition comprising a water-dispersible sulfopolyester according to claim 1.

13. A fibrous article sized with a sizing composition comprising a water-dispersible sulfopolyester having an inherent viscosity of at least 0.1 dL/g measured in a 60/40 parts by weight solution of phenol/tetrachloroethane at 25° C. at a concentration of about 0.25 g of polymer in 100 ml of the solvent and comprising:
(i) a terephthalic acid or derivative thereof;
(ii) less than about 5 mole %, based on the total moles of acid, of at least one dicarboxylic acid that is not terephthalic acid or a derivative thereof, or a sulfomonomer;
(iii) about 25 to about 90 mole %, based on total mole % of hydroxyl equivalents, of at least one polyethylene glycol having the structure:
H—(OCH₂CH₂)ₙ—OH
wherein 2≦n<20 and the mole % of the polyethylene glycol present is inversely proportional to the value of n;
(iv) from greater than about 10 to less than about 75 mole %, based on total mole % of hydroxyl equivalents, of a glycol or mixture of glycols that is not a polyethylene glycol; and
(v) an amount sufficient to provide water-dispersibility to the sulfopolyester of at least one difunctional sulfomonomer selected from a dicrboxylic acid or derivative thereof containing at least one sulfonate group bonded to an aromatic ring, a diol containing at least one sulfonate group bonded to an aromatic ring, and a hydroxy acid or derivative thereof containing at least one sulfonate group bonded to an aromatic ring; wherein the sulfopolyester contains substantially equal molar proportions of acid equivalents (about 100 mole %) and hydroxyl equivalents (about 100 mole %), such that the total of the acid and the hydroxyl equivalents is equal to about 200 mole %.

14. The fibrous article of claim 13, wherein the sizing composition has a Tg of greater than 25° C. and has an inherent viscosity of at least 0.25 dL/g.

15. The fibrous article of claim 13, wherein the sizing composition has a Tg of about 30 to about 65° C.

16. The fibrous article of claim 13, wherein the sizing composition has a Tg of about 35 to about 60° C.

17. The fibrous article of claim 21, wherein the sulfopolyester has an inherent viscosity greater than 0.3 dL/g.

18. A method of sizing a textile yarn comprising contacting said textile yarn with a sizing composition comprising a water-dispersible sulfopolyester according to claim 1 in an amount effective to size said textile yarn.

19. The method of claim 18 further comprising the steps of weaving the sized textile yarn and then desizing the sized textile yarn to remove the sizing composition.

20. The method of claim 19, wherein the sizing composition is permanently applied to the textile yarn.
